(19) United States
(12) Patent Application Publication
(10) Pub. No.: US 2009/0256887 A1
(43) Pub. Date: Oct. 15, 2009

(54) LIQUID DISCHARGE METHOD AND LIQUID DISCHARGE HEAD

(75) Inventors: Takashi Inoue, Kawasaki-shi (JP); Yasuyuki Tamura, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/373,231

(22) PCT Filed: Aug. 8, 2007
(86) PCT No.: PCT/JP2007/065880

§ 371 Date: Jan. 9, 2009

(30) Foreign Application Priority Data
Aug. 29, 2006 (JP) 2006-232181

(51) Int. Cl. B41J 2/14; B41J 2/05

(52) U.S. Cl. 347/47; 347/56

(57) ABSTRACT

A liquid discharge method allowing a liquid inside a flow path to be heated by a heat generating element (2), thereby to generate a bubble by using a liquid discharge head including an orifice plate (4) having a discharge port (5), heat generating elements symmetrically disposed on the surface opposite to the liquid discharge surface of the orifice plate with the discharge port as a center, and the flow path communicating with the discharge port, and allowing liquid discharged from the discharge port by a volume change accompanied with a generation of bubble, wherein bubble is allowed to advance into the discharge port, and a top end of bubble is allowed to reach at least up to liquid discharge surface (8) of the orifice plate, and a columnar liquid inside the discharge port sandwiched between bubbles is separated by a contraction force caused by a surface tension toward the center of the discharge port.

### TECHNICAL FIELD

The present invention relates to a liquid discharge method and a liquid discharge apparatus which granularly discharge a liquid such as an ink by using heat energy, and in particular, it relates to an ink jet recording method and an ink jet recording head which perform recording by discharged ink droplets.

### BACKGROUND ART

As an ink jet recording method, there is a known method in which, by giving heat energy to an ink, the ink is induced to cause a change of state followed by the volume change (generation of bubbles), and the ink is discharged by an acting force based on this change of state. The discharged ink is adhered on a recording medium, thereby performing an image formation.

As one of the basic structures of the recording head for performing the ink discharge, there are structures such as disclosed in U.S. Pat. Nos. 5,841,452, 6,499,832, and 7,101,024. This structure, as shown in FIGS. 9A to 9D, is a structure in which the rear surface (the ink flow path 53 side) of an orifice plate 54 having a discharge port 55 is provided with a heat generating element 52, and this is referred to as a backshooter structure.

For an inkjet recording method, owing to the market needs demanding for a greater precision image and a faster recording, it is desired that, compared to the prior art, small liquid droplets are stably discharged. Particularly, the liquid droplets, so called satellites, which are generated at the rear of the main droplets and still smaller in size than the main droplets often become a primary factor of disturbing a recorded image. Hence, it is sometimes demanded that the generation of the satellites be suppressed. Patent Document 2 discloses that bubbles are formed so as to be substantially doughnut-shaped with the discharge port as a center, and the doughnut-shaped bubbles are expanded and joined together at the bottom (flow path side of the ink) of the discharge port, and the tails of the discharged ink droplets are cut off, thereby the generation of the satellites is suppressed.

However, as a result of the simulation conducted by the present inventor and others to allow the ink to discharge based on the nozzle structure disclosed in U.S. Pat. No. 6,499,832, as shown in FIG. 10, it was not possible to suppress the satellites. FIG. 10 is a sectional view of the nozzle structure showing a discharge condition of ink every 1 μs. At this time, the discharge speed of the ink was 15 m/s.

In FIG. 10, though not shown in detail, the heat generating element is formed ring-shaped. When this heat generating element is energized, bubbles uniformly occur on each part of the heat generating element, and substantially doughnut-shaped bubbles 56 are formed with the discharge port 55 as a center. However, even when the doughnut-shaped bubbles 56 went on expanding, they did not join together (a hole portion of the doughnut did not collapse and disappear) at the bottom of the discharge port 55. Although an attempt was made to increase the electric energy to be given to the heat generating element, the phenomenon has never been confirmed that the bubbles 56 expand at the discharge port 55 side and join together at the bottom of the discharge port 55 in the center side of the doughnut. Further, owing to the ink surrounded by the bubbles 56 and left in the center portion of the discharge port 55, the liquid droplets 57 of the discharged ink were formed with the tails, and it was confirmed that these tail portions were separated so as to generate the satellites 58.

Here, granting that the doughnut-shaped bubbles 56 are expanded and joined together at the bottom of the discharge port 55, at this time, the interior portion of the bubble has already tended to reduce pressure. Besides, the ink is affected by the pressure inside the bubble through a vapor-liquid boundary surface with the bubble 56, so that the end tail of the trailing is pulled into the nozzle side. Consequently, after the ink trailing is formed, the shape of the bubble 56 is simply deformed from the shape of a doughnut to the shape of an ellipse, and it is practically apparent that the generation of the satellites is no longer possible to be suppressed because of the ink trailing created at the initial stage of the discharge.

Further features of the present invention will become apparent from the following description of exemplary embodiments with reference to the attached drawings.

### DISCLOSURE OF THE INVENTION

The present invention has been carried out to solve the above described various problems of the conventional Art and to effectively reduce the generation of the satellites in the ink jet head of the backshooter structure. The specific object of the invention is to provide a new liquid discharge method as well as a new liquid discharge head capable of reducing the generation of the satellites accompanied with the liquid discharge even under the condition of a high discharge speed particularly at 10 m/s or more. By reducing the generation of the satellites, high quality image formation is achieved and the generation of an ink mist is suppressed.

Hence, the liquid discharge method allowing a liquid inside a flow path to be heated by a heat generating element, thereby to generate a bubble by using a liquid discharge head including an orifice plate having a discharge port, a plurality of heat generating elements symmetrically disposed on the surface opposite to the liquid discharge surface of the orifice plate with the discharge port as a center, and the flow path communicating with the discharge port, and allowing the liquid to be discharged from the discharge port by a volume change accompanied with a generation of the bubble, is characterized in that the bubble is allowed to advance into the discharge port, and a top end of the bubble is allowed to reach at least up to the liquid discharge surface of the orifice plate, and a columnar liquid inside the discharge port sandwiched between the bubbles is separated by a contraction force caused by a surface tension toward the center of the discharge port.

According to the present invention, the generation of the satellites can be reduced in the liquid discharge, thereby high quality image formation can be achieved, and the generation of the ink mist around the head can be suppressed, so that the reliability of operation can be improved.

Further features of the present invention will become apparent from the following description of exemplary embodiments with reference to the attached drawings.

### BRIEF DESCRIPTION OF THE DRAWINGS

FIG. 1 is a nozzle sectional view of an ink jet recording head of a first embodiment of the present invention.

FIG. 2 is a top plan view of the ink jet recording head of FIG. 1 seen from a liquid discharge surface side.

FIGS. 3A, 3B, 3C and 3D are views describing an ink discharge process of the ink jet recording head of FIG. 1.

FIG. 4 is a view describing the evaluation standard of a discharge condition and a print condition.

FIG. 5 is a nozzle sectional view of an ink jet recording head of a second embodiment of the present invention.

FIG. 6 is a top plan view of the ink jet recording head of FIG. 5 seen from the liquid discharge surface side.

FIGS. 7A, 7B, 7C, and 7D are views describing the ink discharge process of the ink jet recording head of FIG. 5.

FIG. 8 is a nozzle sectional view of an ink jet recording head of a third embodiment of the present invention.

FIGS. 9A, 9B, 9C, and 9D are nozzle sections showing the ink discharge process in time sequence in the ink jet recording head of a conventional backshooter structure.

FIG. 10 is a view showing a simulation result of the ink discharge in the ink jet recording head of the conventional backshooter structure.

### BEST MODE FOR CARRYING OUT THE INVENTION

Hereinafter, embodiments of the present invention will be described with reference to the drawings. Note that, in each of the following embodiments, an ink jet recording head will be described, which is used for printers and the like and widely spreaded as a liquid discharge head for discharging liquid droplets. The liquid discharge head is also applied as an apparatus for supplying various types of medicines in a predetermined surface pattern, and the present invention is also applicable to such liquid discharge head or liquid discharge method. The liquids to be discharged are not limited to the ink, and may be medicines for chromogenic adjustment. However, in the following, the liquids to be discharged will be simply described as the ink.

### First Embodiment

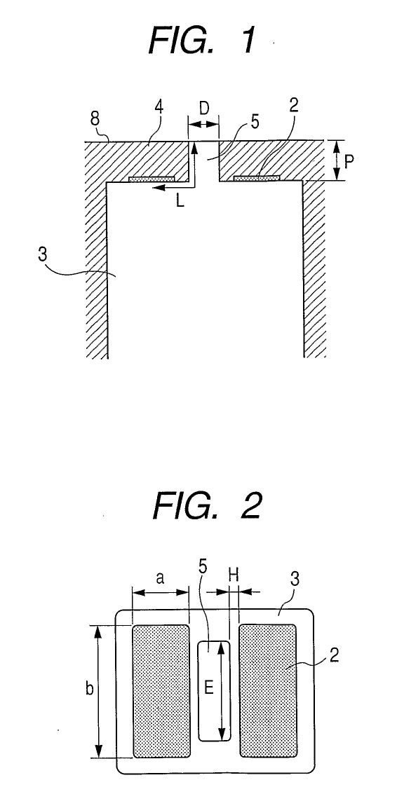

FIGS. 1 and 2 are views showing the main components of the ink jet recording head of the present embodiment. FIG. 1 is a sectional view of the periphery of a discharge port 5, and FIG. 2 is a top plan view of an orifice plate 4 seen from a liquid discharge surface 8 side. In FIG. 2, a heat generating element 2 and a flow path 3 are disposed at the rear surface of an orifice plate 4, and normally invisible from this direction. However, for ease of description, their positions are depicted through the orifice plate 4. Further, in each drawing, the details such as an electric wiring for driving the heat generating element 2 are not illustrated.

As apparent from FIGS. 1 and 2, the basic structure of the ink jet recording head of the present embodiment is a so-called backshooter structure providing the heat generating element 2 at the rear surface (surface opposite to liquid discharge surface 8) of the orifice plate 4 having a discharge port 5.

The heat generating elements 2 are symmetrically disposed with the discharge port 5 as a center. In the present embodiment, more specifically, the discharge port 5 and the heat generating element 2 are rectangle, respectively, and two pieces of the heat generating elements 2 are disposed at both sides of the discharge port 5 so that the long sides thereof are placed in parallel with the long sides of the discharge port 5. The long side of the heat generating element 2 is longer than the length of the corresponding long side of the discharge port 5.

Here, in the drawing, though only one discharge port 5 is shown, in general, the ink jet recording head has a plurality of discharge ports 5. Each discharge port 5 is connected with the ink flow path 3, and the flow path 3, as shown in FIG. 2, approximately extends vertical to the liquid discharge surface 8 in the present embodiment. This ink jet recording head is mounted on an ink jet recording apparatus (not shown) including a driving electrical system of each heat generating element 2 and an ink supply system. Although the detailed description is omitted, in general, the ink jet recording apparatus, in addition to the driving electrical system and the ink supply system, includes a carrying mechanism of a recording medium which changes a relative position of the recording medium and the ink jet recording head and a moving mechanism of the head and the like. By these mechanisms, the ink jet recording apparatus repeats an adjustment of the relative position of the recording medium and the head and a discharge of the ink from each discharge port 5 according to the desired formed image, so that the ink is adhered on an appropriate position of the recording medium so as to form an image.

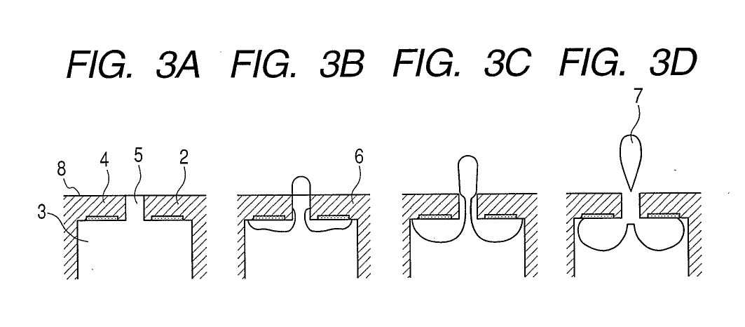

Next, the detail of the discharge of the ink in the ink jet recording head of the present embodiment will be described with reference to FIGS. 3A, 3B, 3C, and 3D. FIGS. 3A, 3B, 3C, and 3D are sections of a head main component showing the discharge condition of the ink at each point of time in time sequence of an ink discharge process. This ink discharge, for example, is performed at 18 m/s in speed of ink droplets, and FIGS. 3A, 3B, 3C, and 3D corresponds to a condition every 0.2 μs at this time.

FIG. 3A shows a state prior to bubbling. From this state, a pulsed voltage is instantaneously applied to the heat generating element 2 so as to let the current flow, thereby heating the ink in the vicinity of the heat generating element 2. As a result, the ink causes a film-boiling so as to generate the bubble 6 (FIG. 3B). At this time, the two heat generating elements 2 can be driven at the same time.

When the bubble 6 continues to expand, it stretches into the discharge port 5 by moving along the inner wall of the discharge port 5 on the discharge port 5 side (FIG. 3C). At this time, each bubble 6 generated by the heat generating elements 2 on both sides which sandwich the discharge port 5 is symmetrically expanded, so that the ink at the center portion of the discharge port 5 is put into a state of being sandwiched between these bubbles 6, and forms a slim ink pole extending to the discharge direction. The smaller the diameter of this ink pole is, the larger the contraction force caused by the surface tension exerted toward the center axial direction of the ink pole, that is, toward the center of the discharge port 5 is, so that the ink pole is easily separated. By separating the ink pole, a liquid droplet 7 to be discharged is suppressed to trail, and the tail portion is separated so that small liquid droplets, that is, the so-called satellites can be suppressed from generating. At this time, by making the long side of the heat generating element 2 longer than the long side of the discharge port 5, the action of separating the ink pole can be stably obtained in the all areas of the discharge port 5.

In the present embodiment, the bubbles 6 symmetrically generated in this way sufficiently come close each other inside the discharge port 5, and by making the quantity of the ink sandwiched between the bubbles 6 reduced, an ink discharge is performed so that the ink pole is separated by an action of the surface tension. This can be realized, as described later more in detail, by appropriately setting the relationship of the discharge port 5 between a size in the direction parallel to the liquid discharge surface 8 and a length in the direction vertical to the liquid discharge surface 8. Further, in the present embodiment, the shape of the discharge port 5 is made rectangle having short sides extending in the direction to connect both of the heat generating elements 2 for generating bubbles 6 so that the bubbles 6 symmetrically generated can easily come close each other. That is, in this configuration, while securing the area of the discharge port 5, the length of the short sides can be made short, thereby the distance between the bubbles 6 symmetrically generated is made short, so that the bubbles 6 are allowed to easily come close each other.

After the ink pole is separated as described above, the bubbles 6 are communicated with the outside air, whereby the ink is completely isolated from the ink at the discharge port 5 side and becomes a short spindle-shaped liquid droplet 7, and is discharged (FIG. 3D). In the present embodiment, the bubbles 6 are communicated with the outside air in this way so as to perform the ink discharge. This can be realized, as described later in detail, by appropriately setting the position and the like of the heat generating elements 2.

Further, at this time, the bubbles 6 can be allowed to communicate with the outside air after going beyond the liquid discharge surface 8 of the orifice plate 4 and beginning to contract. Thereby, when the bubbles 6 communicate with the outside air, a force by the pressure difference is allowed to act in the direction to the inside of the discharge port 5, so that the action such as the suppression of the generation of splashes and the retraction of the separated ink into the discharge port side and the like can be obtained.

After the ink is discharged, a gap generated in the top end portions of the discharge port 5 and the flow path 3 by the discharge is filled again (refilled) with the ink by wettability with the surface tension of the ink and the inner wall, that is, a capillary force, and the ink is restored to the state prior to the discharge (FIG. 3A).

Next, a detail of the nozzle structure which realizes a preferable ink discharge capable of reducing the generation of the satellites as described above will be described.

First, a condition necessary for the bubbles to advance into the discharge port and expand beyond the liquid discharge surface of the orifice plate is considered.

Since the majority of the work W performed by the bubble for the ink is considered to be impulsively performed immediately after bubbling, the following formula is established.

W≈I²/(2A)

In the formula, I stands for an impulse of the pressure by bubbling, and A stands for an inertance of the liquid area when the heat generating element is taken as a pressure source.

An impulse I of the pressure by the bubbling can be approximately estimated as I˜P_{b}τ(τ is a time in which the bubble pressure becomes 1/e from the initial pressure P_{b}).

An inertance A can be analytically calculated as A≡−ρ/(∫_{SH}5966 φdS_{H}). Here, ∇²φ=0, φ=1 in the heat generating element surface, φ=0 in the discharge port surface, ρ is an ink density, and S_{H} is the area of the heat generating element.

Assuming that the pressure of the bubble is lowered to a pressure of saturated vapor Pₛ immediately after bubbling, when kinetic energy of the liquid when a bubble volume becomes the maximum is neglected, the maximum bubble volume Vₘ can be determined from Vₘ˜W/(Pₐ−Pₛ)≈W/Pₐ=P_{b}²_{τ}²/(2APₐ). Here, Pₐ is an atmospheric pressure.

Assuming that the bubble is a semi-circle in order that the bubble advances into the discharge port and expands beyond the orifice plate surface, a radius of the semi-circular bubble at the time of the maximum bubble volume Vₘ needs only to go beyond a distance L from the center of the heat generating element to the orifice plate surface, and so, the following conditions are obtained.

L<(3Vₘ/2_{π})^{1/3}

L<(3P_{b}²_{τ}²/(4_{π}APₐ)^{1/3}

Here, in the present invention, the bubble, as described above, expands along the rear surface of the orifice plate serving as a forming surface of the heat generating element, and further when grown on the discharge port side, expands along the discharge port inner wall surface (see FIGS. 3B and 3C). Consequently, the distance L is a distance measured along the orifice plate rear surface and the discharge port inner wall surface (see FIG. 1).

When the above described formulas are substituted by the atmospheric pressure Pₐ=101.3 kPa, the initial pressure P_{b}=8584 kPa (which is taken as a pressure of saturated vapor of water at 300° C. as an assumed initial pressure of the bubble at the film-boiling time), and τ=0.1 μs (assumed value determined experimentally and theoretically), the following formula can be obtained.

L<(1737/A)^{1/3}(unit of A is [g/cm³/μm])

The inertance A can be also roughly approximated as A˜ρL/S_{H}. According to this formula, the above described condition can be rewritten to L<(1737 S_{H}/ρ)^{1/4}.

Further, similarly to the present embodiment, the case where the heat generating elements are rectangle respectively and the long sides thereof face the discharge port is considered. In this case, the bubble can be approximated to the one having half the shape cut in the surface including a long axis and a short axis of the ellipsoidal body in which a ratio of the short axis and the long axis is equal to the ratio of the short side and the long side of the heat generating element. At this time, the condition under which the bubble expands beyond the orifice plate surface can be corrected as a condition under which the radius in the short axis direction of the maximized bubble goes beyond L, and when the length of the short side of the heat generating element is taken as a [μm], and the length of the long side is taken as b [μm], the following formulas are obtained.

L<(3Vm/2_{π}·a/b)^{1/3}

L<(1737a²/ρ)^{1/4}

Generally speaking, in these formulas, a can be said to be a length of the heat generating element along a straight line connecting the center of the heat generating element and the center of the discharge port.

Next, when the bubbles reach the orifice plate surface under the above described condition, consideration is given to a condition under which the bubbles symmetrically generated with the discharge port as a center sufficiently come close each other inside the discharge port. By satisfying this condition, the quantity of the ink left inside the discharge port at the bubble forming time is made little, and immediately after the discharge, a rapid separation is performed between the top head portion of the ink droplet and the ink inside the nozzle, so that the generation of the satellites can be reduced by suppressing a long trailing.

Here, a thought experiment will be given on the growth of the bubble generated from the heat generating element. Assuming that the bubble is allowed to expand to the extent of going beyond the orifice plate surface by using the heat generating element capable of controlling the maximum expanded volume of the bubble, this bubble is communicated with the atmosphere, thereby losing expandability. That is, the reach distance of the liquid boundary surface of the bubble is to the extent of the distance from the center of the heat generating element to the orifice plate surface even at the maximum. Further, the reach distance of a vapor-liquid boundary surface of the bubble from the edge of the discharge port inlet side (flow path side) to the edge of the discharge port outlet side along the discharge port inner wall surface is considered to be equal to the reach distance from the edge of the discharge port inlet side in the discharge port center direction. Consequently, when the discharge port diameter is larger than an orifice plate thickness, the reach distance in the discharge port center direction of the vapor-liquid boundary surface of the bubble is approximately equal to the orifice plate thickness even at the maximum.

Next, the case will be considered, in which the bubbles are simultaneously generated from the two heat generating elements symmetrically positioned by sandwiching the discharge port. In this case, when the discharge port diameter is assumed to be equal to or below two times the orifice plate thickness, it is apparent that the vapor-liquid boundary surfaces of the bubbles generated from each heat generating element can be made to hit against each other in the center of the discharge port.

More generally, since the discharge port can be made also rectangle similarly to the present embodiment, by using a width D [μm] of the discharge port measured along the straight line connecting a center point of the heat generating element and a center point of the discharge port which are symmetrically located and an orifice plate thickness P [μm], a condition can be set. That is, at this time, a condition under which the bubbles symmetrically generated with the discharge port as a center are allowed to sufficiently come close each other inside the discharge port is as follows.

2P≧D

P≧D/2

When the head was prepared so as to actually satisfy the above described condition, it was confirmed that the bubbles generated from each heat generating element came close each other in the discharge port center, and at the same time, the ink flows created by each bubble hit against each other in the center of the discharge port, and the scanty ink sandwiched between both bubbles was left behind in the center of the discharge port. As a result, the desired discharge operation was obtained, in which the generation of the satellites was reduced.

At this time, the structure of the nozzle is conceivable to be of wide variations in the range of satisfying the above described condition. Hence, in reality, the confirmation of a discharge condition and a recording condition was made on the heads (Examples 1-1 to 6) of various nozzle structures in the range of the above described condition and the heads (Comparison Examples 1-1 to 3) of nozzle structures out of the range of this condition. The result is shown in Table 1.

TABLE 1

| | Discharge/ | | | | | | |
|---|---|---|---|---|---|---|---|
| | Recording | P | S_{O} | S_{H} | L | (1737/A)^{1/3} | (1737/A)^{1/4} |
| | conditions | (μm) | (μm) | (μm) | (μm) | (μm) | (μm) |
| Example 1-1 | A | 5 | 4 × 16 | 7 × 18 | 9.5 | 24.9 | 17.1 |
| Example 1-2 | A | 5 | 8 × 8 | 7 × 18 | 10.5 | 23.3 | 17.1 |
| Example 1-3 | B | 7 | 8 × 8 | 7 × 18 | 12.5 | 21.6 | 17.1 |
| Example 1-4 | C | 10 | 8 × 8 | 7 × 18 | 14.5 | 20.9 | 17.1 |
| Example 1-5 | B | 10 | 14 × 14 | 8 × 25 | 15 | 27.4 | 18.3 |
| Example 1-6 | C | 12 | 10 × 20 | 8 × 25 | 18 | 24.2 | 18.3 |
| Comparison | D | 10 | 8 × 8 | 7 × 18 | 19.5 | 18.3 | 17.1 |
| Example 1-1 | | | | | | | |
| Comparison | D | 5 | 14 × 14 | 8 × 25 | 10 | 31.7 | 18.3 |
| Example 1-2 | | | | | | | |
| Comparison | D | 15 | 14 × 14 | 8 × 25 | 24 | 23.4 | 18.3 |
| Example 1-3 | | | | | | | |

In Table 1, Sₒ stands for an area of the rectangular discharge port 5, and represents a length D of the short side multiplied by a length E of the long side, and an area S_{H} of the rectangular heat generating element 2 also represents a length a of the short side multiplied by a length b of the long side.

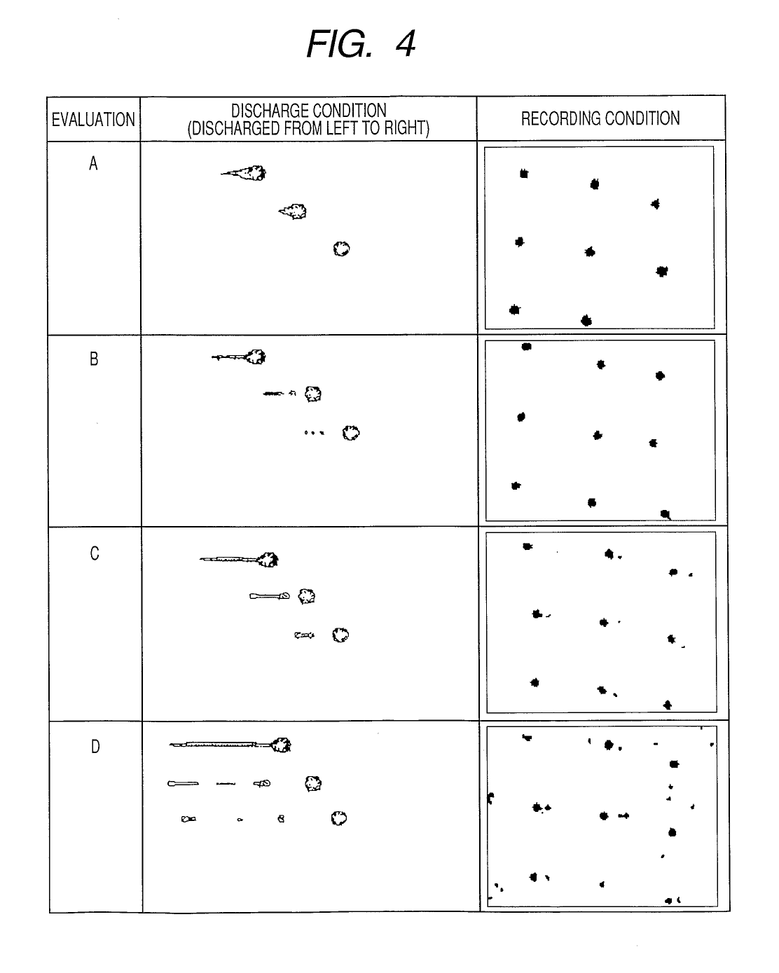

The states of the discharge and recording were confirmed by using the ink with Density ρ=1 g/cm³, Surface Tension y=50 mN/m, and Viscosity η=2 cp, and shows an estimated result. At this time, in the discharge observation, it was confirmed that the discharge speed was 15 m/s or more. In the estimation result, as shown in FIG. 4, the case where the satellites were not recognized in the discharge observation was taken as A, whereas, though the satellites were recognized in the discharge observation, since the satellite grain size was small (specifically 3 μm or below), in the conformation of the recording condition, the case where the effect of the satellites was ignorable was taken as B. In the discharge observation, the case where the number of large satellites was averagely two or less was taken as C. The other cases were taken as D.

According to Table 2, it is apparent that the implementation (Examples 1-1 to 6) of the above described conditions: P≧D/2 and L<(1737/A)^{1/3} is a condition to obtain a good discharge. At this time, though these conditions, as described above, are derived by using the estimation values for P_{b} and τ, from the result of Table 1, it is considered to be confirmed that an approximately correct estimation can be made by using these estimation values.

The inertance A in the above described condition is a value analytically determined. However, from Table 1, in this condition, even when an approximate value (1737a²)^{1/4} is used in place of the estimation value (1737/A)^{1/3} for L, it is apparent that such value becomes a reasonable condition to obtain a good discharge.

Further, if the conditions of P≧D/2 and L<(1737/A)^{1/3} are satisfied, and further, L is made sufficiently small (readable as equal to or below half the value from the Table) as compared with (1737/A)^{1/3}, then, it is apparent that the best discharge without causing the satellites can be obtained. Consequently, to provide the structure satisfying such conditions is more favorable.

At this time, since L stands for a distance along the nozzle inner wall surface from the center of the heat generating element to the orifice plate surface, when the distance of the heat generating element from the side of the discharge port side to the edge of the discharge port inner wall surface is taken as H [μm], if the discharge port is not given an inclination, the following formula is established.

L=a/2+H+P

In this formula, a length a of the short side of the heat generating element and a thickness P of the orifice plate are limited also by the condition for obtaining the above described good discharge, and there is a limit in making the length short. Consequently, making L sufficiently short is substantially synonymous with making H sufficiently short. The case where the side facing the discharge port side of the heat generating element is made consistent with the edge of the inner wall surface of the discharge port is equivalent to a lower limit O of H, and making H sufficiently short is equivalent to satisfy the following formula from Table 1.

O≦H<3

That is, providing the nozzle structure which satisfies the above described conditions P≧D/2 and L<(1737/A)^{1/3} and the above described condition of H, as basic conditions, the generation of the satellites can substantially be prevented.

As described above, according to the present embodiment, the ink discharge suppressing the generation of the satellites can be realized, thereby the disturbance of the image is suppressed and a high quality image formation is achieved, and the generation of the ink mist is suppressed around the head, and the reliability of the recording operation can be improved.

The detail of the present embodiment does not limit the present invention, and various modifications can be made within the scope of the invention. For example, giving a taper of 0 to 5 degrees can be to the area of the discharge side of the discharge port so as to be made smaller than the area of an inlet side to obtain discharge stability, and to such structure also, the present invention can be applied. Further, the discharge port may be circular.

Further, the present invention presupposes the backshooter structure symmetrically disposing the heat generating elements with the discharge port as a center on the rear surface of the liquid discharge surface. On the other hand, it is known that, in a so-called side shooter structure also in which the heat generating element is provided at a position opposing to the discharge port, the discharge having few satellites can be obtained by using the communication of the bubbles by bringing the distance between an ink inlet of the discharge port and the heat generating element closer. In contrast to this, in the configuration for reducing the generation of the satellites in the backshooter structure of the present invention, no restriction is imposed on the flow path of the ink connected to the discharge port. Hence, the present invention also has the advantages that the flow path is easily configured to be small in flow resistance, and as a result, a quick refilling can be easily realized.

### Second Embodiment

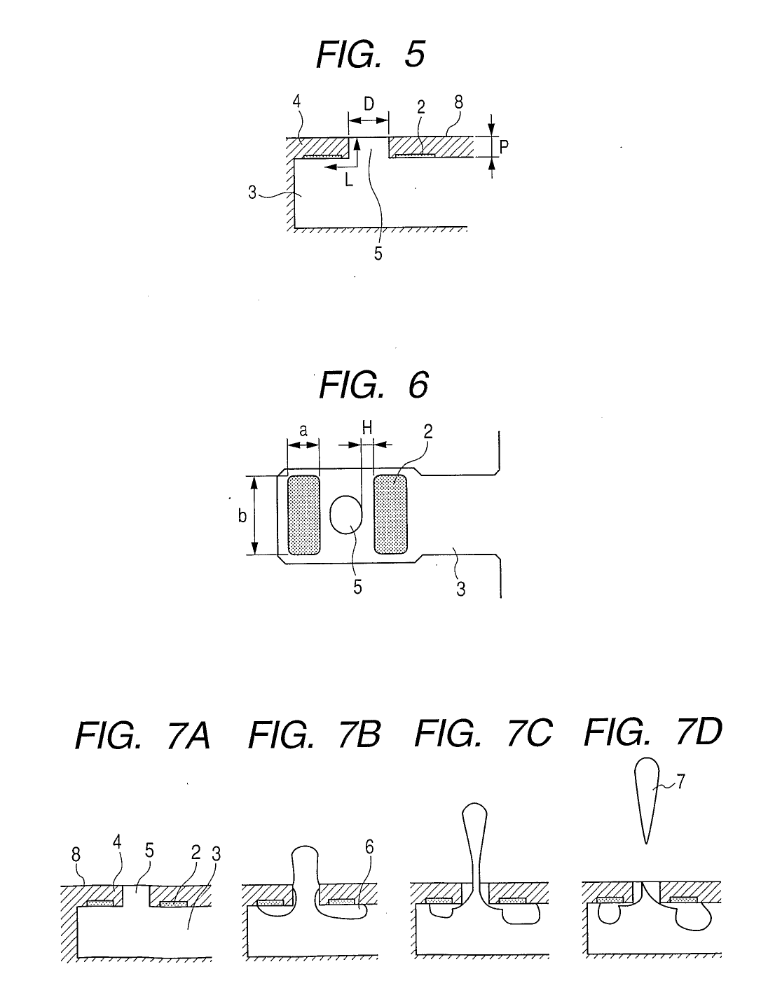

FIGS. 5 and 6 are views showing main components of an ink jet recording head of the present embodiment. FIG. 5 is a sectional view of the periphery of a discharge port 5, and FIG. 6 is a top plan view of an orifice plate 4 seen from a liquid discharge surface 8 side. In these drawings, the same parts as the first embodiment are provided with the same reference numerals, and the detailed description thereof will be omitted.

The present embodiment is different in the configuration of a flow path 3 from the first embodiment, and the flow path 3 extends in a direction parallel with the liquid discharge surface 8. Further, the discharge port 5 is circle in the present embodiment.

As a heat generating element 2, two rectangular elements are provided, and they are disposed at the positions opposite each other by sandwiching the circular discharge port 5. Each heat generating element 2 is disposed such that one of the long sides is opposed to the discharge port 5, and the long side of each heat generating element 2 is longer than the diameter of the discharge port 5.

FIGS. 7A, 7B, 7C, and 7D are views for describing the process in which, in the ink jet recording head of the present embodiment, the ink inside the flow path 3 is heated, and the ink droplets are discharged from the discharge port 5.

FIG. 7A shows a state prior to bubbling. FIG. 7B shows a state in which the bubble 6 generated by the application of a pulse voltage to the heat generating element 2 advances into the discharge port 5, that is, extends along the inner wall surface of the discharge port 5.

FIG. 7C shows a state in which the bubbles generated by two heat generating elements 2 respectively come close in the center portion of the discharge port 5, and as a result, an ink pole formed between these bubbles is separated by the surface tension. In this way, a condition under which the bubbles are allowed to sufficiently come close each other so as to separate the ink pole is the same as the first embodiment, and the ink jet recording head of the present embodiment is configured to satisfy this condition.

FIG. 7D shows a state in which the bubble finally communicates with the outside air, whereby the liquid droplet 7 is completely separated from the ink at the discharge port 5 side, and as a result, the discharge suppressing the generation of the satellites is performed. In this way, the condition under which the bubble communicates with the outside air is also the same as the first embodiment, and the ink jet recording head of the present embodiment is configured to satisfy this condition.

In the present embodiment, a result of confirmation of the discharge condition and the recording condition regarding the heads (Examples 2-1 to 5) of various nozzle structures in the range of the above described condition and the heads (Comparison Examples 2-1 to 3) of nozzle structures out of the range of this condition is shown in Table 2. The height (length in the direction vertical to the liquid discharge surface 8) of the flow path 3 was all taken as 15 μm.

TABLE 2

| | Discharge/ | | | | | | |
|---|---|---|---|---|---|---|---|
| | Recording | P | D | S_{H} | L | (1737/A)^{1/3} | (1737/a²)^{1/4} |
| | conditions | (μm) | (μm) | (μm) | (μm) | (μm) | (μm) |
| Example 2-1 | A | 5 | 8 | 8 × 16 | 11 | 21.9 | 18.3 |
| Example 2-2 | C | 8 | 8 | 8 × 16 | 15 | 19.4 | 18.3 |
| Example 2-3 | A | 10 | 8 | 8 × 16 | 15 | 18.4 | 18.3 |
| Example 2-4 | B | 10 | 16 | 10 × 20 | 16 | 27.8 | 20.4 |
| Example 2-5 | B | 15 | 16 | 10 × 20 | 20 | 25.2 | 20.4 |
| Comparison | D | 10 | 8 | 8 × 16 | 20 | 17.9 | 18.3 |
| Example 2-1 | | | | | | | |
| Comparison | D | 5 | 16 | 10 × 20 | 12 | 31.2 | 20.4 |
| Example 2-2 | | | | | | | |
| Comparison | D | 15 | 16 | 10 × 20 | 26 | 24.2 | 20.4 |
| Example 2-3 | | | | | | | |

Similarly to the first embodiment, in Table 2, as an area S_{H} of the oblong heat generating element 2, a length a of the short side multiplied by a length b of the long side is represented. Further, for the confirmation also of the discharge condition and the recording condition, similarly to the first embodiment, the ink of Density ρ=1 g/cm³, Surface Tension y=50 mN/m, and Viscosity τ=2 cp was used, and in the discharge observation, it was confirmed that the discharge speed of 15 m/s or more was realized. The evaluation standard of the discharge and recording conditions was also the same as the first embodiment.

According to Table 2, it is apparent that the conditions: P≧D/2 and L<(1737/A)^{1/3} are conditions to obtain a good discharge. Further, it is apparent that the condition using an approximate value (1737a²)^{1/4} in place of the estimation value (1737/A)^{1/3} for L is also reasonable as a condition to obtain a good discharge.

The present embodiment, as described above, a member forming a flow path bottom is located at a position opposite to the heat generating element 2, and between this member and the orifice plate 4, the flow path 3 is configured to be formed. At this time, in the present embodiment, by satisfying the above described condition, the generation of the satellites can be suppressed, and this condition does not restrict a height of the flow path 3, that is, a distance between the member opposite to the heat generating element 2 and the orifice plate 4. Consequently, while enabling the generation of the satellites to be suppressed, this distance can be made long, whereby the flow resistance in the flow path 3 is suppressed small, and a rapid refilling can be made.

### Third Embodiment

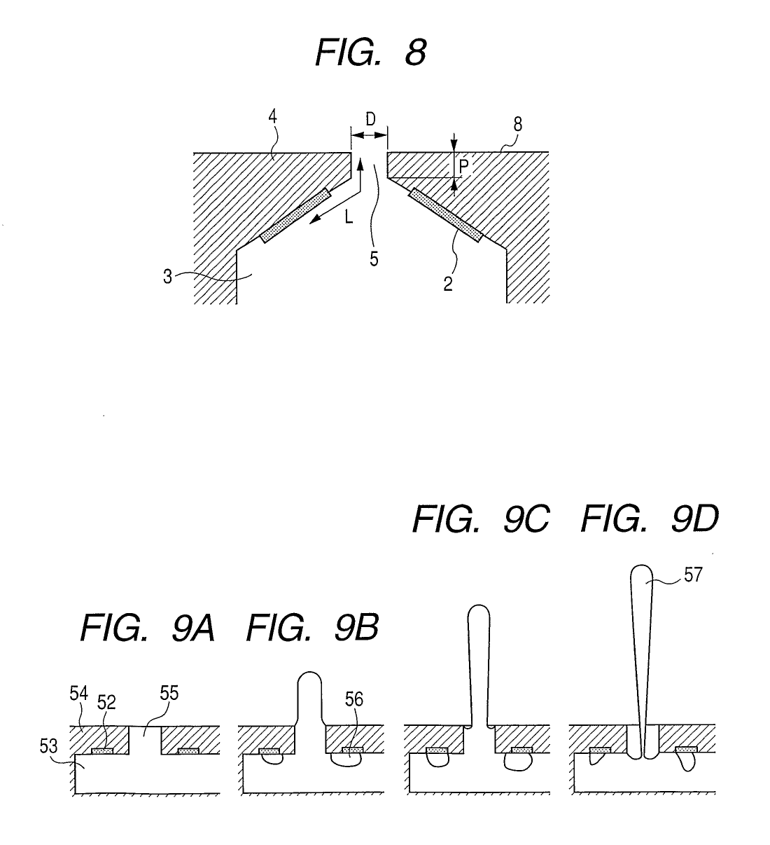

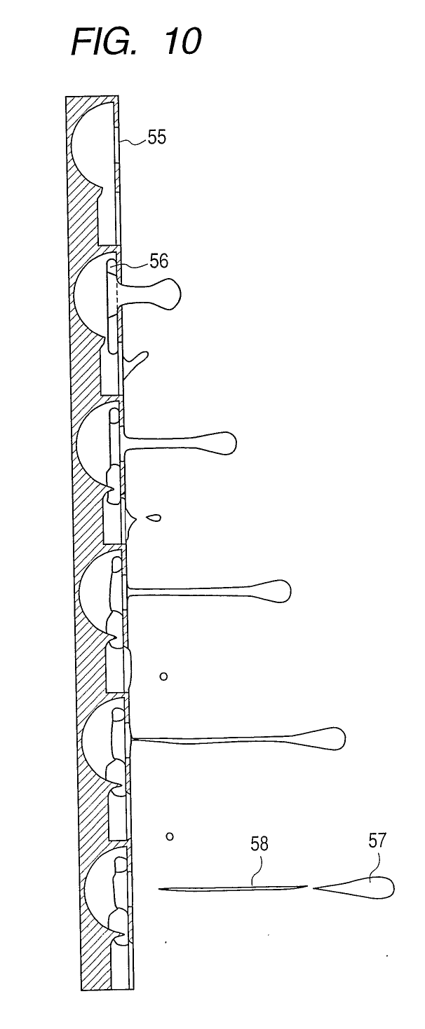

FIG. 8 is shown a sectional view of main components of an ink jet recording head of the present embodiment. In the drawing, the same parts as the first and second embodiments are provided with the same reference numbers, and the detailed description thereof will be omitted.

A heat generating element 2 provided at the rear surface of an orifice plate 4 needs not to be disposed in parallel with a liquid discharge surface 8 of the orifice plate 4. In the present invention, a head may be configured to allow the bubble generated from each heat generating element 2 to advance into a discharge port 5 and enable a top end of each bubble to reach up to the liquid discharge surface 8 of the orifice plate 4. The present embodiment is such an example, and the orifice plate 4 includes an inclined surface allowing a distance from the liquid discharge surface 8 to be longer as isolated from the discharge port 5 at the opposite side of the liquid discharge surface 8, and the heat generating element 2 is disposed on this inclined surface.

In the case of the present embodiment, the thickness P [μm] of the orifice plate under the condition for suppressing the generation of the satellites shown in the first and second embodiments is required to be replaced by a length in the direction vertical to the liquid discharge surface 8 of the discharge port 5. That is, in general, the above described P is defined in this way. Except for this, by satisfying the same conditions as the first and second embodiments, the ink discharge which suppresses the generation of the satellites can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-232181, filed Aug. 29, 2006 which is hereby incorporated by reference herein in its entirety.

1. A liquid discharge method allowing a liquid inside a flow path to be heated by a heat generating element, thereby to generate a bubble by using a liquid discharge head comprising an orifice plate having a discharge port, a plurality of heat generating elements symmetrically disposed on the surface opposite to the liquid discharge surface of the orifice plate with the discharge port as a center, and the flow path communicating with the discharge port, and allowing the liquid to be discharged from the discharge port by a volume change accompanied with a generation of the bubble, wherein
the bubble is allowed to advance into the discharge port, and a top end of the bubble is allowed to reach at least up to the liquid discharge surface of the orifice plate, and a columnar liquid inside the discharge port sandwiched between the bubbles is separated by a contraction force caused by a surface tension toward the center of the discharge port.

2. The liquid discharge method according to claim 1, wherein the bubble and the atmosphere are communicated during a period in which, after the top end of the bubble reaches the liquid discharge surface of the orifice plate, the bubble contracts and returns into the discharge port.

3. The liquid discharge method according to claim 1, wherein the plurality of the heat generating elements are driven at the same timing.

4. A liquid discharge head, comprising:
an orifice plate having a discharge port;
a plurality of heat generating elements symmetrically disposed on the surface opposite to the liquid discharge surface of the orifice plate with the discharge port as a center; and
a flow path communicating with the discharge port,
wherein the liquid inside the flow path is heated by the heat generating elements so as to generate a bubble, and by a volume change accompanied with the generation of the bubble, the liquid is allowed to discharge from the liquid discharge surface through the discharge port,
wherein, by taking a length in the direction vertical to the liquid discharge surface of the discharge port as P [μm] and by taking a length of the discharge port along a straight line connecting each center point of the heat generating elements mutually positioned symmetrically with the discharge port as a center and a center point of the discharge port as D [μm],
P≧D/2 is satisfied, and
wherein, by taking a distance from the center point of the heat generating element along the flow path and the inner wall surface of the discharge port to the liquid discharge surface as L [μm], and by taking the inertance of the liquid area when the heat generating element is taken as a pressure source as A [g/cm³/μm], L<(1737/A)^{1/3} is satisfied.

5. The liquid discharge head according to claim 4, wherein the inertance A is calculated as A≡−ρ/(∫_{SH}∇φdS_{H}) by taking ∇²φ=0, φ=1 in the heat emitting surface, φ=0 in the discharge port surface, density of the liquid taken as ρ[g/cm³], and the area of the individual heat emitting surface as S_{H} [μm²].

6. A liquid discharge head, comprising:
an orifice plate having a discharge port;
heat generating elements symmetrically disposed on the surface opposite to the liquid discharge surface of the orifice plate with the discharge port as a center; and
a flow path connecting with the discharge port,
wherein the liquid inside the flow path is heated by the heat generating elements so as to generate a bubble, and by a volume change accompanied with the generation of the bubble, the liquid is allowed to discharge from the liquid discharge surface through the discharge port,
wherein, by taking a length in the direction vertical to the liquid discharge surface of the discharge port as P [μm] and by taking a length of the discharge port along a straight line connecting each center of the heat generating elements mutually positioned symmetrically with the discharge port as a center and a center point of the discharge port as D [μm],
P≧D/2 is satisfied, and
wherein, by taking a distance from the center point of the heat generating element along the flow path and the inner wall surface of the discharge port to the liquid discharge surface as L [μm], and by taking the area of the heat generating element as S_{H} [μm²], and by taking the density of the liquid as ρ[g/cm³],
L<(1737S_{H}/ρ)^{1/4} is satisfied.

7. The liquid discharge head according to claim 4, wherein the heat generating elements are rectangle respectively, and a long side of the heat generating element faces the discharge port, and a length of the long side is longer than a length of the discharge port in the direction of the long side.

8. A liquid discharge head, comprising:
an orifice plate having a discharge port;
heat generating elements symmetrically disposed on the surface opposite to the liquid discharge surface of the orifice plate with the discharge port as a center; and
a flow path communicating with the discharge port,
wherein the liquid inside the flow path is heated by the heat generating elements so as to generate a bubble, and by a volume change accompanied with the generation of the bubble, the liquid is allowed to discharge from the liquid discharge surface through the discharge port,
wherein, by taking a length in the direction vertical to the liquid discharge surface of the discharge port as P [μm] and by taking a length of the discharge port along a straight line connecting each center of the heat generating elements mutually positioned symmetrically with the discharge port as a center and a center point of the discharge port as D [μm],
P≧D/2 is satisfied, and
wherein, by taking a distance from the center point of the heat generating element along the flow path and the inner wall surface of the discharge port to the liquid discharge surface as L [μm], and by taking a length of the heat generating element along a straight line connecting the center of the heat generating element and the center of the discharge port as a [μm], and by taking a density of the liquid as ρ[g/cm³],
L<(1737a²/ρ)^{1/4} is satisfied.

9. The liquid discharge head according to claim 4, wherein, by taking a distance from a side facing the discharge port side of the heat generating element to the edge of the inner wall surface of the discharge port as H [μm],
P≧D/2 and 0≦H<3 are satisfied.

10. The liquid discharge head according to claim 4, wherein the discharge port is tapered to be smaller as proceeding to the liquid discharge surface side.
